(19) United States
(12) Patent Application Publication
(10) Pub. No.: US 2008/0277886 A1
(43) Pub. Date: Nov. 13, 2008

(54) Clamping Device

(76) Inventor: Ralph Peter, Lauffen (DE)

Correspondence Address: BERENATO, WHITE & STAVISH, LLC, 6550 ROCK SPRING DRIVE, SUITE 240, BETHESDA, MD, 20817, US

(21) Appl. No.: 11/997,170

(22) PCT Filed: Feb. 5, 2007
(86) PCT No.: PCT/US07/03173

§ 371 Date: Jan. 29, 2008

(30) Foreign Application Priority Data
Apr. 13, 2006 (EP) 06007873.0

(51) Int. Cl. B23B 5/22

(52) U.S. Cl. 279/60

(57) ABSTRACT

The present invention relates to a clamping device for clamping tools, having a receptacle (2) that is surrounded by an annular space (3). The annular space (3) is open toward the workpiece-side end surface (1a) of the chuck body (1) and toward the receptacle (2), and is closed off by an cover (5). Configured in the receptacle-side inner wall of the cover (5) is an annular groove (13) in which a sealing ring (12) is arranged; a liquid can be delivered to the annular groove (13) in order to press inward the sealing ring (12) that is inserted into the annular groove (13) and thus actively seal a gap formed between the cover (5) and a tool (W) inserted into the receptacle (2).

The present invention relates to a clamping device for clamping tools, having a basic body in which are configured a central receptacle for the shaft of a tool to be clamped, as well as an annular space surrounding the receptacle, the annular space being open toward the workpiece-side end surface of the chuck body and toward the receptacle.

Clamping devices of this kind are known, for example, from WO 00/76703 and serve to immobilize a tool shaft, such as e.g. a drill or milling-cutter shaft, on the working spindle of a corresponding machine tool. They are used in particular to clamp small tools.

In the context of the clamping devices known from WO 00/76703, the tools are clamped by way of a shrink fit. For this purpose they are usually made up of a basic body, made of metal, that comprises a central receptacle for the shaft of the tool to be clamped. The diameter of the receptacle is dimensioned so that it is somewhat smaller than the diameter of the tool shaft. To clamp the tool, the basic body is heated, at least in the region of the receptacle, until the latter has thermally expanded sufficiently that the tool shaft can be inserted into it. Upon subsequent cooling, the receptacle shrinks again so that the tool shaft is immobilized in the receptacle with a press or shrink fit.

Alternatively, other clamping mechanisms can be used. Possibilities are, for example, the clamping mechanisms of the Applicant's so-called Tribos clamping chucks, which are described in DE 198 27 101 C1 and DE 198 34 739 A1.

Clamping devices of this kind have proven entirely successful in practical use. Because of the “hard” clamping of the shaft, however, flexing effects can occur during use that can ultimately cause breakage of the entirely carbide shaft of the tool. WO 00/76703 proposes, for this reason, to provide a damping space around the receptacle. This configuration makes the clamping of the tool shaft “softer,” with the consequence that “propeller shaft” effects, which as a result of hard clamping of the shaft and can lead to tool breakage, can be ruled out or largely prevented.

The fact that chips, etc. can collect in the damping cavities is, however, regarded as disadvantageous. Because such chip buildups occur in irregular fashion in the damping cavities, they inevitably result in an imbalance that is disadvantageous in the context of the occasionally very high rotation speeds of machine tools.

Also viewed as disadvantageous is the fact that when tools having internal coolant delivery are used, in particular with clamping mechanisms that operate according to the Applicant's Tribos technology, the cooling liquid can travel through gaps that form between the receptacle and the clamped tool to the tool-side end surface of the clamping device, and be discharged.

It is therefore the object of the present invention to configure a clamping device of the kind cited above in such a way that imbalances are substantially avoided, and a discharge of cooling liquid is furthermore prevented.

This object is achieved, according to the present invention, in that the open end of the annular space is closed off by an annular cover that is inserted into the annular space from the latter's open end face and is immobilized in the annular space; and that there is configured in the receptacle-side inner wall of the cover an annular groove in which a sealing ring is arranged, the annular groove being connected to a liquid delivery conduit through which a liquid can be delivered to the annular groove in order to press inward the sealing ring that is inserted into the annular groove and thus actively seal a gap formed between the cover and a tool inserted into the receptacle.

The invention is thus based on the idea of at least partially closing off the annular space and thus counteracting the entry of chips, etc.

The cover inserted for this purpose into the annular space additionally comprises sealing means in the form of at least one sealing ring inserted into the annular groove of the cover, which ring can be actively compressed in such a way that it abuts against the periphery of a tool shaft inserted into the receptacle and in this fashion seals the receptacle-side annular gap by the fact that the annular groove is acted upon by a liquid. When the liquid pressure is reduced again, the sealing ring pushes back into its initial position because of its elastic return force. This configuration makes it possible effectively to prevent any discharge of coolant at the tool-side end surface of the clamping device during operation, especially when tools with internal coolant delivery are used. Tools can be inserted into the receptacle without damaging the sealing ring because the inside diameter of the sealing ring can be larger than the shaft diameter of the tool.

In an embodiment of the invention, provision can be made that the annular groove configured in the receptacle-side inner wall of the cover is supplied via the liquid delivery conduit with a cooling liquid that is delivered to the clamping device in order to cool the tool. This embodiment is particularly suitable when the clamping device is designed for the use of tools having internal coolant delivery, and is correspondingly equipped with internal coolant supply ducts.

According to an embodiment of the invention, provision is made that the liquid delivery conduit comprises a conduit portion configured in the basic body and opening into the basic-body-side end surface of the cover and a conduit portion adjacent thereto and configured in the cover, which latter portion is open toward the annular space and can be embodied, for example, as a blind hole. Multiple liquid delivery conduits can also be provided in order to supply liquid to the annular groove configured in the receptacle-side inner wall of the cover. In this case the liquid delivery conduits are usefully arranged with a regular distribution in the circumferential direction of the cover.

According to a preferred embodiment of the invention, provision is made in this context that the cover is configured, and immobilized in the annular space, in such a way that the static stiffness of the clamping device is substantially not influenced.

In a further embodiment of the invention, provision is made that the cover is embodied as a damping element and by preference is suspended in freely oscillating fashion in the annular space. It is possible, for example, to retain the cover in freely oscillating fashion in the annular space by means of an O-ring or multiple O-rings. This embodiment of the invention is based on the idea of effecting damping specifically in the outermost region of the tool clamping system where the highest oscillation speeds occur during operation, specifically above the cover, which is mounted in the annular space in oscillating fashion, i.e. with a clearance and with elastic cushioning, so that a relative motion can take place between the cover and the basic body. The clamping device according to the present invention thus constitutes a multiple-mass oscillator whose damping properties can be modified by using differently configured covers, with the consequence that damping can be achieved for a wide variety of frequencies, and the resonant frequency of the clamping device can thus be adjusted. The damping can be preset by varying length L of the cover (viewed in the axial direction of the clamping device).

A short length L produces less damping, while a longer length L yields greater damping. Further influencing capabilities result from the material density of the cover. Experiments have shown that good results can be achieved even with small damping masses. Small masses are important for the rotating system, since inertial forces during acceleration and deceleration can be kept low.

When O-rings are used to immobilize the cover in the annular space, grooves for receiving the O-rings can be provided in the outer wall of the cover and/or the inner wall of the annular space. In addition, it is useful to secure the cover in the annular space by way of positively and/or frictionally engaged connections, to prevent falling out.

According to a preferred embodiment, provision is made that the cover is secured in the annular space by a snap ring that engages into corresponding annular grooves on the outer wall of the cover and the inner wall of the annular space.

With regard to further advantageous embodiments of the invention, reference is made to the dependent claims and to the description that follows, referring to the attached drawings in which:

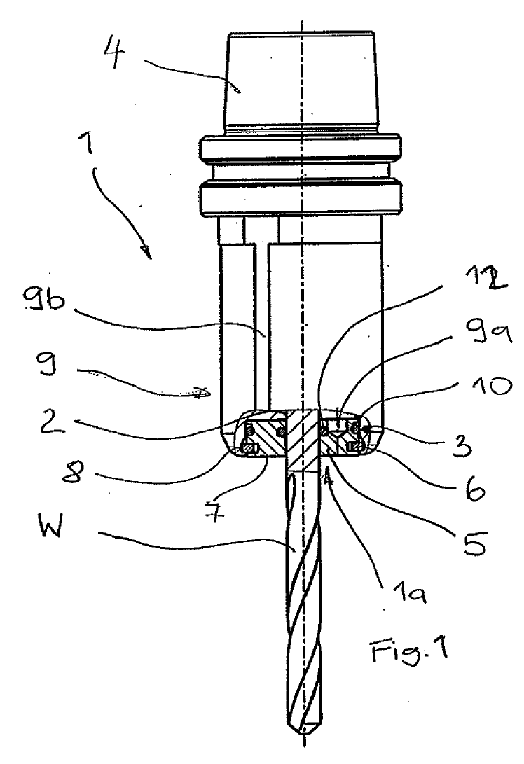

FIG. 1 is a partially sectioned front view of an embodiment of a clamping device according to the present invention;

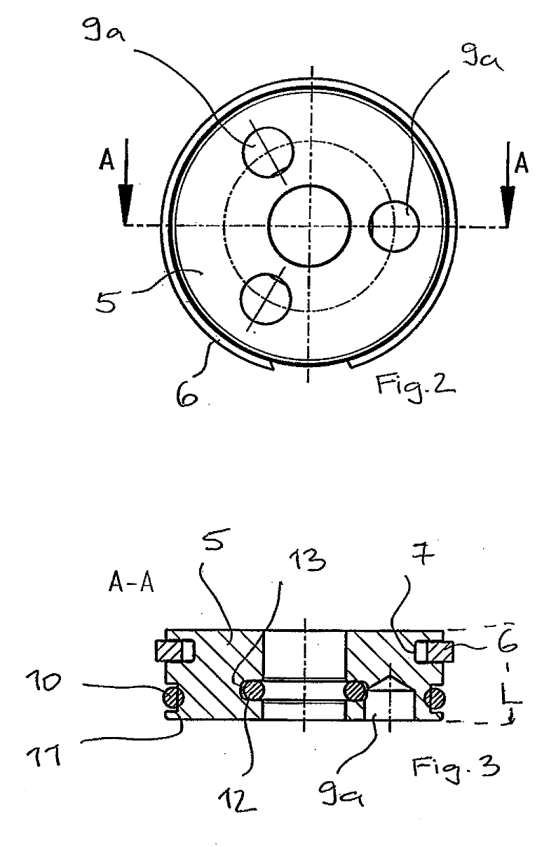

FIG. 2 is an enlarged front view of a cover for closing off the annular space of the clamping device according to FIG. 1; and

FIG. 3 shows the cover in section along line A-A in FIG. 2.

FIG. 1 depicts an embodiment of a clamping device according to the present invention for clamping tools, which is embodied here as a clamping chuck but can also, for example, be integrated directly into the working spindle of a machine tool. The clamping chuck encompasses a basic body 1 made of a dimensionally stable material such as, for example, steel, which body comprises at its one end region a central receptacle 2 for the cylindrical shaft of a tool W (in this case a drill) to be clamped. At its other end region basic body 1 comprises, in a manner known per se, an interface 4 for clamping into the working spindle of a machine tool.

Provided in basic body 1 is an annular space 3 that surrounds the front region of receptacle 2 and is open toward tool-side end surface 1a of the basic body and toward receptacle 2. An annular cover 5 is inserted into annular space 3 and is axially immobilized by a snap ring 6 that engages into corresponding annular grooves 7, 8 in the outer wall of cover 5 and the inner wall of annular space 3. The annular gap formed between the outer wall of cover 5 and the inner wall of annular space 3 is sealed by an O-ring 10 that is held in a further annular groove 11 in the outer wall of cover 5.

Additionally configured on the inner wall of cover 5 is an annular space 13 into which is inserted a sealing ring that is embodied here as O-ring 12. O-ring 12 possesses an inside diameter that is somewhat larger than the diameter of receptacle 2 and of the tool shaft to be fitted. The O-ring can, however, be elastically compressed by application of a hydraulic pressure, and in this manner pressed against the shaft of a clamped tool W in order to seal the gap formed between the inner cover wall and tool W. Annular groove 13 is connected for this purpose, via three coolant delivery conduits 9, to a central coolant delivery conduit (not depicted in detail) through which the clamping device is connected to an external coolant source in order to supply coolant to the clamping device when tools with internal coolant delivery are used. As is clearly evident from the Figures, the three liquid delivery conduits 9 are arranged around annular groove 13 with a regular distribution, i.e. with an offset of approximately 120° from one another, and extend substantially axially through the clamping device. They each possess a conduit portion 9a provided in cover 5, which portion is embodied in the form of a blind hole introduced into the end face of cover 5 and intersecting with annular groove 13 in its outer circumferential region; and a conduit portion 9a, adjacent thereto, that is configured in basic body 1 and opens into the central coolant supply conduit of the clamping device.

When a tool W is immobilized in the clamping device during operation, and coolant delivery to the clamping device is activated, a pressure builds up in annular groove 13 with the consequence that O-ring 12 is pressed elastically against the clamped tool shaft, and in this fashion the annular gap between cover 5 and tool W is sealed.

In the context of the clamping device depicted, cover 5 constitutes a damping element that can perform relative motions with respect to basic body 1. Clamping device 1 according to the present invention thus constitutes a mass oscillator whose damping properties can be modified by the use of different covers 5, with the consequence that damping can occur at different frequencies and the resonant frequency of the clamping device can thus be adjusted. Possibilities for variation exist in terms of the length L, density, and hardness of cover 5. Damping is effected specifically in the external region of the tool clamping system, where the highest oscillation speeds occur during operation.

1. A clamping device for clamping tools, having a basic body (1) in which are configured a central receptacle (2) for the shaft of a tool (W) to be clamped, as well as an annular space (3) surrounding the receptacle (2), the annular space (3) being open toward the workpiece-side end surface (1a) of the chuck body (1) and toward the receptacle (2),
wherein the annular space (3) is closed off by an cover (5) that is inserted into the annular space (3) from the open end face (1a) and is immobilized in the annular space (3); and there is configured in the receptacle-side inner wall of the cover (5) an annular groove (13) in which a sealing ring (12) is arranged, the annular groove (13) being connected to a liquid delivery conduit (9a, 9b) through which a liquid can be delivered to the annular groove (13) in order to press inward the sealing ring (12) that is inserted into the annular groove (13) and thus actively seal a gap formed between the cover (5) and a tool (W) inserted into the receptacle (2).

2. The clamping device according to claim 1, wherein the annular groove (13) configured in the receptacle-side inner wall of the cover (5) is supplied via the liquid delivery conduit (9a, 9b) with a cooling liquid that is delivered to the clamping device in order to cool the tool (W).

3. The clamping device according to claim 1, wherein the liquid delivery conduit (9a, 9b) comprises a conduit portion (9b) configured in the basic body (1) and opening into the basic-body-side end surface of the cover (5), and a conduit portion (9a) adjacent thereto and configured in the cover (5).

4. The clamping device according to claim 1, wherein multiple liquid delivery conduits (9a, 9b) are provided in order to supply liquid to the annular groove (13) configured in the receptacle-side inner wall of the cover (5).

5. The clamping device according to claim 4, wherein the liquid delivery conduits (9a, 9b) are arranged with a regular distribution in the circumferential direction of the cover (5).

6. The clamping device according to claim 5, wherein the cover (5) is configured, and immobilized in the annular space (3), in such a way that the static stiffness of the basic body (1) is substantially not impaired.

7. The clamping device according to claim 5, wherein the cover (5) is embodied as a damping element and is suspended in freely oscillating fashion in the annular space (3).

8. The clamping device according to claim 7, wherein the cover (5) is retained in freely oscillating fashion in the annular space (3) by means of at least one O-ring (10).

9. The clamping device according to claim 8, wherein a groove (13) for receiving the at least one O-ring (10) is provided in the outer wall of the cover (5) and/or the wall of the annular space (3).

10. The clamping device according to claim 1, wherein the cover (5) is secured in the annular space (3) by a snap ring (6).
